(19) United States
(12) Patent Application Publication
(10) Pub. No.: US 2008/0069555 A1
(43) Pub. Date: Mar. 20, 2008

(54) Digital Camera Structure

(75) Inventor: Tzu-Chih Lin, Jhudong Township (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: ALTEK CORPORATION, Hsinchu (TW)

(21) Appl. No.: 11/626,733

(22) Filed: Jan. 24, 2007

(30) Foreign Application Priority Data
Sep. 15, 2006 (TW) 095216513

(51) Int. Cl. G03B 17/38

(52) U.S. Cl. 396/502

(57) ABSTRACT

A digital camera structure is provided, which is used for preventing deviation of a preset optical axis caused by a reaction force generated when pressing a shutter button. A conductive element parallel to the optical axis and located on a pressing path of the shutter button is disposed in the digital camera. By pressing the shutter button, the conductive element is deformed and reset in a direction parallel to the preset optical axis. Thus, the vibration in a direction perpendicular to the optical axis is prevented, thereby not influencing the imaging quality.

### CROSS-REFERENCE TO RELATED APPLICATIONS

This non-provisional application claims priority under 35 U.S.C. § 119(a) on Patent Application No(s). 095216513 filed in Taiwan, R.O.C. on Sep. 15, 2006, the entire contents of which are hereby incorporated by reference.

### BACKGROUND OF THE INVENTION

1. Field of Invention

The present invention relates to a digital camera structure, and more particularly, to a digital camera structure for preventing the vibration in a direction perpendicular to a preset optical axis.

2. Description of the Related Art

Currently, as the rapid progress of science and technology, many new 3C (computer, communication, consumer electronics) digital products are brought the new out of the old, and the price has gradually become cheaper. Among them, consumable image capturing devices, such as mobile phones, PDAs, and digital cameras with image shooting functions, are increasingly popular, especially the digital cameras, which have completely taken place of conventional cameras using films due to the advantages that it is convenient for being used and the pictures shot by the digital cameras can be viewed instantly. Therefore, nowadays, the digital cameras have become convenient tools in people's daily life or work.

Generally, lenses and sensing units of a digital camera are independently disposed at different positions within the camera, and then they are optically aligned, such that they are positioned in a direction of the same optical axis. As digital cameras have become increasingly smaller in volume and lighter in weight now, the stability of hands is often insufficient when a user holds a light and thin digital camera with the hand, which easily leads to vibration, which is also called “hand shake”. Moreover, as the shutter button structure of a conventional digital camera is designed not to be parallel to the optical axis, after the user presses the shutter button, the reset mechanism of the shutter button, such as a spring or a blade spring, instantly makes the shutter button restore to the original position. Thus, a reaction force that does not parallel to the optical axis is generated, which causes the vibration of the user's hand while holding the digital camera, so one of the independently disposed lenses or sensing units deviate from the position of the optical axis. Therefore, the shot images are deviated in angles, and even blurred, which severely influences the image quality of the target.

Currently, many manufacturers have developed various digital cameras with the anti-shake function. The anti-shake mode is roughly classified into three types, namely, an optical anti-shake mode, an electronic anti-shake mode, and a photosensitive element anti-shake mode, which are all used to perform an optical compensation to the deviation occurred between the lens or the sensing unit and the optical axis when the shutter button is pressed down. As for the optical anti-shake mode, a group of floating correction lenses is added in the lens, and the position of the correction lenses is adjusted through the detection of a sensor, so as to correct the deviation between the lens and the optical axis caused by the “hand shake”. As for the electronic anti-shake mode, images recorded by an image sensor are read to a processing module of the camera, and the deviated parts in continuous images are compared and then corrected. As for the photosensitive element anti-shake mode, also referred as CCD shift anti-shake, a sensor is used to enable the charged coupled device (CCD) to move towards a direction opposite to the shaking direction once the shutter button is pressed down, so as to reduce the optical deviation caused by the “hand shake”. Furthermore, a fixing bracket also can be used, such that the digital camera is stably placed on the bracket while shooting, so as to solve the problem of the poor stability when the user holds the camera.

The conventional anti-shake modes all use electronic elements to perform the optical compensation, and adjust the deviation to the optical axis through floating correction lenses or a CCD; or a bracket is used to solve the shaking problem when the user holds the light and thin digital camera. However, the problem is still left unsolved that the digital camera shakes in a direction that does not parallel to the optical axis due to the reaction force generated when the reset mechanism bounces the shutter button back after the shutter button is pressed down.

### SUMMARY OF THE INVENTION

In view of the above problems, the present invention is directed to providing a digital camera structure, so as to solve the problem that the camera easily shakes in a direction that does not parallel to an optical axis due to a reaction force generated in a direction that does not parallel to the optical axis when the reset mechanism is deformed and reset after a shutter button of a conventional digital camera is pressed down.

To achieve the aforementioned object, the digital camera structure of the present invention includes a housing and an elastic conductive element. A lens and a sensing unit located in the same preset optical axis with the lens are disposed in the housing, and a button that is movable upon being pressed is disposed on the housing. The conductive element suspends within the housing, and it is in contact with the button, thus, when the button is pressed down, the conductive element is deformed and reset in a direction parallel to the preset optical axis.

The efficacy of the present invention lies in enabling a click direction between the shutter button and the conductive element to be parallel to the optical axis, such that after the shutter button is pressed down, the reaction force generated when the conductive element is deformed and reset is parallel to the direction of the optical axis, so as to prevent the digital camera from shaking in a direction that does not parallel to the optical axis, and further prevent blurred images.

The above description on the content of the present invention and the following description on the embodiments below are intended to demonstrate and explain the principle of the present invention, and provide further explanation on the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic stereogram of the present invention;

FIG. 2 is a partial perspective view of the present invention;

FIG. 3A is an enlarged partial perspective view of the present invention;

FIG. 3B is a top perspective view of FIG. 3A;

FIG. 4A is a schematic view of operations of the present invention;

FIG. 4B is a top perspective view of FIG. 4A;

FIG. 5A is a schematic view of operations of the present invention; and

FIG. 5B is a top perspective view of FIG. 5A.

### DETAILED DESCRIPTION OF THE INVENTION

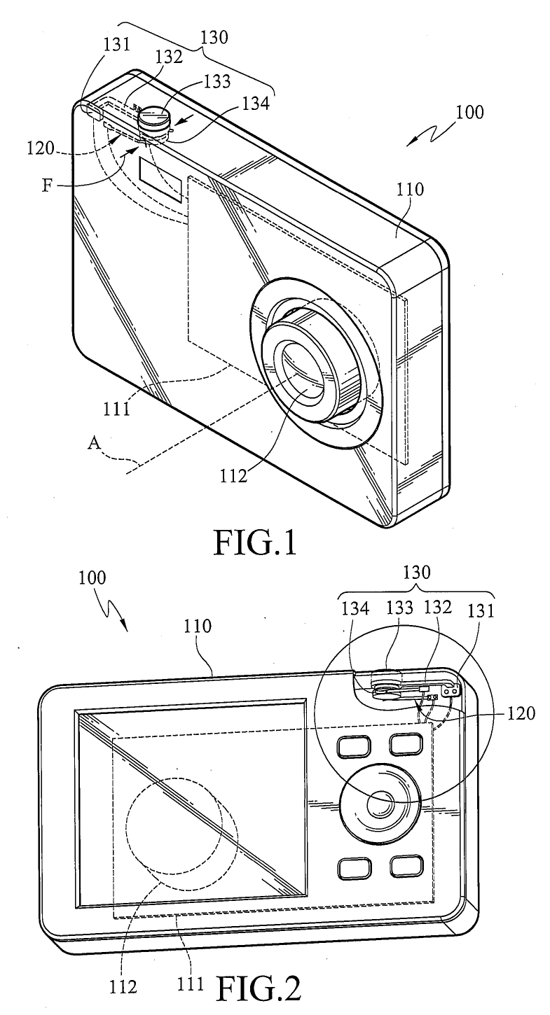

FIGS. 1 to 3B are schematic stereogram and partially enlarged schematic views of the present invention. As shown in the figures, a digital camera structure 100 disclosed in the present invention includes a housing 110 and a conductive element 120. The housing 110 has an accommodation space, and a lens 112 and a sensing unit 111 located in a direction of the same preset optical axis A as the lens 112 are disposed within the accommodation space, so as to perform the image capturing function of the digital camera 100. A button 130 that is movable upon being pressed by a user is disposed on the housing 110. The conductive element 120 is elastic and suspends within the housing 110, and it is in contact with the button 130. When the button 130 is pressed down and shifted, the conductive element 120 is deformed and reset in a direction parallel to the optical axis A. Herein, the button 130 disclosed in the present invention is a shutter button for performing the image capturing function.

As shown in FIGS. 1 to 3B, the conductive element 120 has a fixed end 121 fixed to an inner sidewall of the housing 110 and a contact end 122 extending from the fixed end 121 and suspending within the accommodation space and parallel to the optical axis A. The contact end 122 further includes an elastic bent portion 1221 and an urge portion 1222 extending from the bent portion 1221. The shutter button 130 includes a fixed portion 131 fixed to the inner sidewall of the housing 110, a cantilever 132 extending from the fixed portion 131 and parallel to the conductive element 120, a pressing portion 133 connected to the cantilever 132 and movably disposed on the housing 110, and a contact portion 134 extending from the pressing portion 133 and in contact with the conductive element 120. The contact portion 134 of the shutter button 130 is movably disposed in the contact end 122 of the conductive element 120, and it is in contact with the urge portion 1222, such that the shutter button 130 has a pressing position to be electrically contacted with the conductive element 120, and a reset position to be insulated from the conductive element 120. When the user presses down the shutter button 130, the click direction between the shutter button 130 and the conductive element 120 is parallel to the optical axis A, such that the reaction force F generated when the conductive element 120 is deformed and reset is also parallel to the optical axis A, so as to reduce the shakes occurring in the direction that does not parallel to the optical axis A while the user holds the digital camera 100 with the hand.

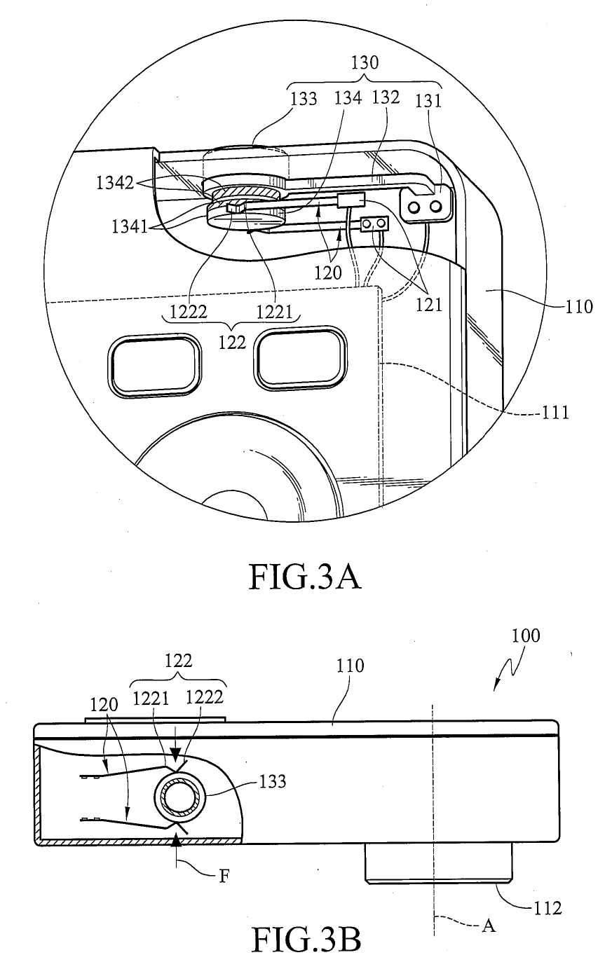

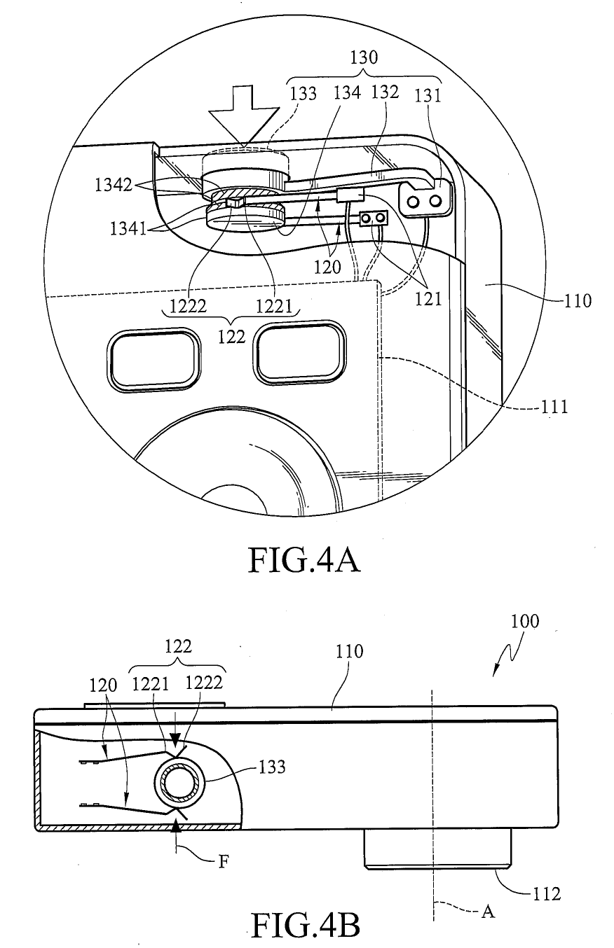

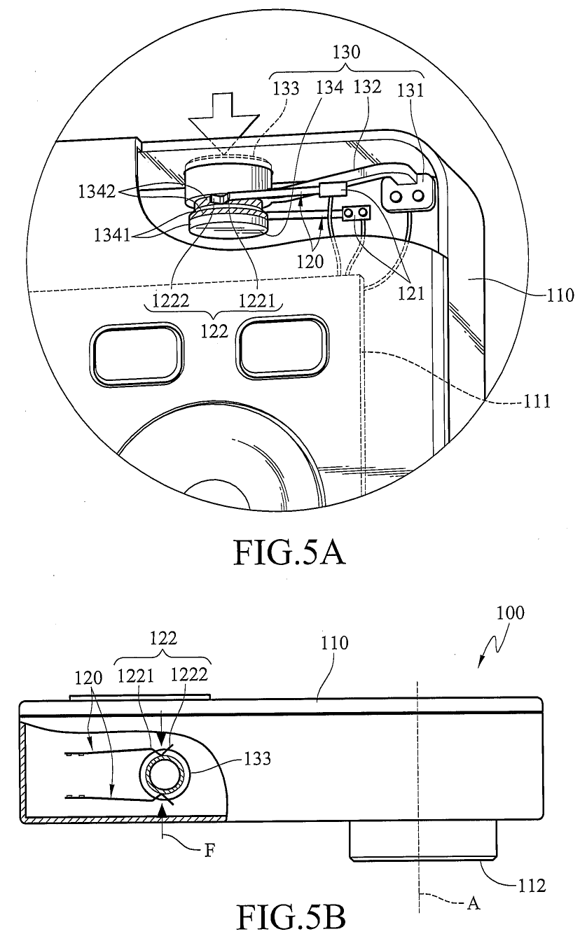

FIGS. 3A to 5B are schematic views of operations that the digital camera of the present invention performs the image retrieving function. As shown in the figures, the contact portion 134 of the shutter button 130 further includes two non-conductive regions 1341 and two electrical contact regions 1342 arranged along the axial direction of the shutter button 130, which are alternately disposed in the contact portion 134. The two electrical contact regions 1342 are used to perform different image capturing functions for the digital camera 100 respectively. The fixed portion 131 and the cantilever 132 of the shutter button 130 enable the urge portion 1222 of the conductive element 120 to urge against the non-conductive regions 1341 in the normal state, such that the shutter button 130 is maintained at the reset position in the normal state where the shutter button 130 is insulated from the conductive element 120. The two electrical contact regions 1342 of the present invention are used to perform the functions of focusing on the target image and capturing the target image respectively. However, the functions of the electrical contact regions 1342 are not limited in the embodiment of the present invention.

As shown in FIGS. 3A to 5B, when the user presses the pressing portion 133 of the shutter button 130, the contact portion 134 of the shutter button 130 moves downwards accordingly, such that the non-conductive region 1341 at the bottom end of the contact portion 134 is detached from the urge portion 1222 of the conductive element 120, and an electrical contact region 1342 is electrically contacted with the conductive element 120 to output a signal, so as to perform the focusing function. Moreover, the click direction of the contact portion 134 and the urge portion 1222 is parallel to the optical axis A, such that the reaction force F generated by the shutter button 130 is also in the same direction as the optical axis A, so as to prevent the digital camera 100 from shaking in a direction that does not parallel to the optical axis A.

When the user continues to press down the button, the other non-conductive region 1341 of the contact portion 134 is contacted with the urge portion 1222 to form an insulating state. Moreover, a slope structure is disposed at the outer edge of the non-conductive region 1341 disposed between the two electrical contact regions 1342. When the user continuously presses the shutter button 130, the urge portion 1222 of the conductive element 120 is forced to slide across the non-conductive region 1341 having the slope structure, and it is electrically contacted with the electrical contact region 1342 at the top end of the contact portion 134, so as to perform the operation of capturing a target image. When the user releases the force applied on the shutter button 130, the contact portion 134 restores to the reset position where it is insulated from the contact end 122. Furthermore, as the click direction of the contact portion 134 and the urge portion 1222 is parallel to the direction of the optical axis A, after the shutter button 130 is pressed down, the reaction force F generated due to the reset and deformation between the conductive element 120 and the shutter button 130 is also parallel to the optical axis A, so as to minimize the influence of the shake of the camera. Moreover, the autofocus function puts an end to the slight shakes of the digital camera 100, so clear images can be obtained.

Compared with the conventional art, in the digital camera structure of the present invention, the click direction between the shutter button and the conductive element is parallel to the direction of the optical axis A. Therefore, when the user presses down the shutter button, the reaction force generated when the conductive element is deformed and reset is in the same direction as the optical axis A, so as to prevent the digital camera from shaking in the direction perpendicular to the direction of the preset optical axis A, thereby further preventing the problem that the shot images are blurred.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital camera structure, comprising:
a housing, with a lens and a sensing unit located in the same optical axis as the lens being disposed therein, and a button that is movable upon being pressed being disposed thereon; and
an elastic conductive element, suspending within said housing and contacting with said button, wherein when said button moves, said conductive element is deformed and reset in a direction parallel to the optical axis.

2. The digital camera structure as claimed in claim 1, wherein said button is a shutter button.

3. The digital camera structure as claimed in claim 1, wherein said conductive element includes a fixed end fixed to said housing, and a contact end in contact with said button.

4. The digital camera structure as claimed in claim 3, wherein the contact end further includes an elastic bent portion and an urge portion in contact with said button.

5. The digital camera structure as claimed in claim 1, wherein said button includes a fixed portion fixed to said housing, a cantilever extending from the fixed portion, a pressing portion connected to the cantilever and movably disposed in said housing, and a contact portion extending from the pressing portion and disposed in said conductive element.

6. The digital camera structure as claimed in claim 5, wherein the contact portion further includes two non-conductive regions and two electrical contact regions, which are alternately arranged along an axial direction of said button, and in a normal state, the contact portion is maintained at a reset position where the contact portion is insulated from the contact end.

7. The digital camera structure as claimed in claim 6, wherein a slope structure is disposed at an outer edge of the non-conductive region disposed between the two electrical contact regions.
